(19) United States
(12) Patent Application Publication
(10) Pub. No.: US 2005/0248224 A1
(43) Pub. Date: Nov. 10, 2005

(54) Flat-type vibration motor

(76) Inventor: Young II Park, Gwangju-si (KR)

Correspondence Address: BIRCH STEWART KOLASCH & BIRCH, PO BOX 747, FALLS CHURCH, VA, 22040-0747, US

(21) Appl. No.: 10/517,839

(22) PCT Filed: Jul. 21, 2003
(86) PCT No.: PCT/KR03/01444

§ 371 Date: Dec. 15, 2004

(30) Foreign Application Priority Data
Jul. 23, 2002 (KR) 10-2002-0043218

(51) Int. Cl. H02K 7/06

(52) U.S. Cl. 310/81

(57) ABSTRACT

A flat vibration motor of the present invention has a coil placed at a position lower than an upper portion of a rotor and received completely in the rotor so that the coil is not exposed to exterior nor shaken. The flat vibration motor of the present invention improves operation reliability of a vibration motor further.

### TECHNICAL FIELD

The present invention relates to a flat vibration motor, and more particularly, to a flat vibration motor to prevent a coil from swelling up due to high temperature caused during surface mount device (SMD) operation. Further, the present invention relates to a flat vibration motor to maintain stable motion of a vibration motor by suppressing the coil from swelling up so that the original shape of a rotor can be held.

### BACKGROUND ART

A flat vibration motor is used to realize a vibration function in a personal information communication machine such as a mobile communication terminal (i.e. a beeper, mobile telephone, etc.) or in environment requiring vibration.

FIG. 1 is a cross-sectional view of a conventional flat vibration motor.

Referring to FIG. 1, the conventional flat vibration motor includes a dish-shaped lower case 2, a substrate 3 installed on the lower case 2, a magnet 4 fixed at the lower case, for generating predetermined magnetic field, an upper case 1 formed on an upper portion of the lower case 2 and defining a predetermined space therein, a rotating shaft 5 supported between the upper case 1 and the lower case 2, a rotator 6 axially installed onto the rotating shaft 5, and a brush 7 fixed at the substrate 3 so as to apply electric power to the rotator 6.

FIG. 2 is a plan view of a rotator employed in the conventional flat vibration motor.

Referring to FIG. 2, construction of a conventional rotator 6 will be described in detail. A rotator 6 consists of a base 61 made of synthetic resin in a circular form, a bearing 64 coupled with rotation center of the base 61, a fan-shaped weight 63 centering around the bearing 64 and disposed in a predetermined region of the base 61, a coil 62 provided on a side of the weight 63, and a commutator 65 (shown in FIG. 1) installed on a bottom of the coil 42.

The base 61 is a member made of synthetic resin by injection mold and has insertion grooves so as to dispose the bear 64, the coil 62 and a weight 63 at proper locations.

The vibration motor causes vibration when the weight center of the rotator 6 is shifted from the center of the vibration motor due to the weight 63 to be eccentric and the vibration motor rotates.

The magnet 4 is disk-shaped and magnetized to have N and S poles alternatively. When the coil generates predetermined magnetic field due to supplied electric power, magnetic fields generated by the coil 62 and the magnet 4 interact with each other so that the rotator 6 rotates and causes vibration.

The operation of the conventional flat vibration motor configured as described above will be described.

Most of all, if electric power is applied to the coil 62 through the brush 7 formed on the substrate 3 and the commutator 65 of the rotator 6, the magnetic fluxes of the coil 62 and the magnet 4 interlink and electromagnetic force causes the eccentric rotation. This eccentric rotation causes vibration.

Meanwhile, it is general to perform soldering in surface mount device (SMD) so as to fix the flat vibration motor to the substrate 3.

Soldering is usually called brazing. The soldering is the essential technique in installing electronic elements on a substrate and gets more important in miniaturizing and lightening electronic devices.

In the soldering in SMD technique, solder cream is used. The solder cream is liquid at room temperature and contains conductive material such as lead. The solder cream is coated on the adhesion portions of the substrate in print technique and the vibration motor is mounted on the substrate. After that, the vibration motor and the substrate are heated with heating means such as a reflow machine so that the solder cream is melt to adhere the vibration motor to the substrate.

It is possible to supply proper amount of solder cream to the adhesion portions. The solder cream has adhesion at room temperature so that the location of the elements is maintained. Owing to batched heating, a plurality of element are soldered simultaneously. Accordingly, the productivity is high so that this is used to mount electronic element on a substrate very often recently. Here, the heating temperature required to melt the solder cream in the SMD technique is about 245° C.

However, the conventional flat vibration motor configured as described above has problems in which its coil 62 swells up due to the heat expansion caused by high temperature (245° C.) generated during SMD process since the height of the end of the coil 62 inserted into the base 61 is the same as the height of the end of the base 61. Since the coil 62 is exposed to the exterior at the upper surface of the base 61, the means to suppress the coil's expansion and swelling up. Furthermore, since the bottom of the coil 62 is supported by the base 61 and commutator 65, the coil 62 is expanded due to heat toward the upper side of the base 61 when coil 62 is expanded due to heat. Therefore, the coil 62 swells up upward more seriously.

On the other hand, the expanded coil 61 collides with the upper case 1.

As described above, the coil 62 swells up so that the quality of the vibration motor deteriorates. So, it is required urgently to improve the above-mentioned problems.

### DISCLOSURE OF THE INVENTION

Accordingly, the present invention is directed to a flat vibration motor that substantially obviates one or more of the problems due to limitations and disadvantages of the related art.

An object of the present invention is to provide a flat vibration motor that operates stably.

Another object of the present invention is to provide a flat vibration motor that can solve the aforementioned problems without any additional element.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a flat vibration motor comprises an upper case; a lower case; a conductive substrate formed on an upper surface of the lower case; a magnet formed on the upper surface of the lower case, for generating magnetic field; a conductive brush having an end connected to the substrate; a rotational shaft supported at an approximate center portion between the lower case and the upper case; a rotator inserted onto the rotational shaft and formed of base made of resin, for rotating; a commutator formed on a lower surface of the rotator and connected to the other end of the brush; and a coil having an upper portion formed at a position lower than an upper portion of the rotator.

In an aspect of the present invention, a flat vibration motor comprises a case; a rotational shaft standing at a center portion of the case; a rotator formed upon a circumference of the rotational shaft and made of resin; a coil recessed into the rotator so that the coil is firmly fixed when heated; and a power supply means for supplying a predetermined electric power to the coil.

In another aspect of the present invention, a flat vibration motor comprises an upper case having an open lower side; a lower insulating fixer formed on the lower side of the upper case; a magnet formed on an inner bottom surface of the upper case, for generating magnetic field; a rotational shaft standing at a center portion of the upper case and the lower fixer; a rotator inserted onto the rotational shaft and formed of base made of resin, for rotating; a conductive terminal formed a lower side of the lower fixer; a brush penetrating the lower fixer and having an end connected to the terminal and the other end connected to a commutator formed on a lower side of the rotator; and a coil having an upper portion formed at a position lower than an upper portion of the rotator.

In a further aspect of the present invention, a flat vibration motor comprises a case; a rotational shaft standing inside the case; a rotator placed upon a circumference of the rotational shaft; a coil received in the rotator so that the coil is not exposed to exterior; and a commutator and a brush for supplying a predetermined electric power to the coil.

According to the present invention, the reliability on the performance of a flat vibration motor can be further improved. Also, the defective proportion of the vibration motor can be reduced thanks to the simple structural improvement.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional view illustrating a conventional flat vibration motor;

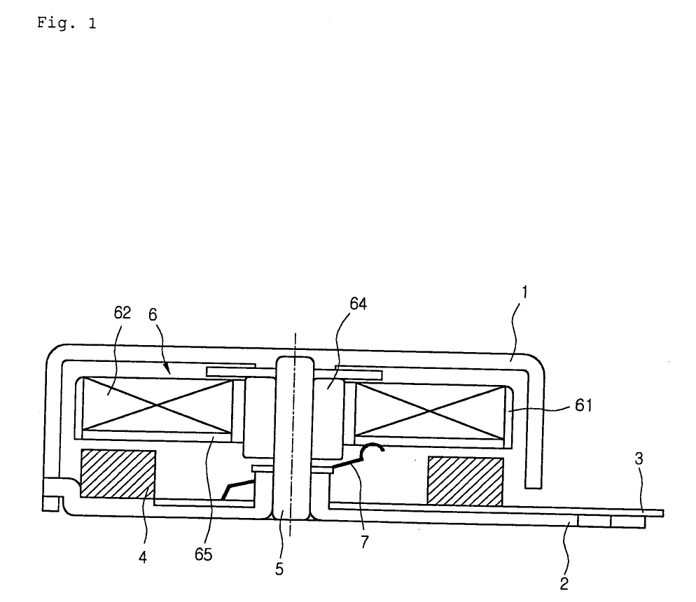

FIG. 2 is a plan view illustrating a rotator adapted to the conventional flat vibration motor;

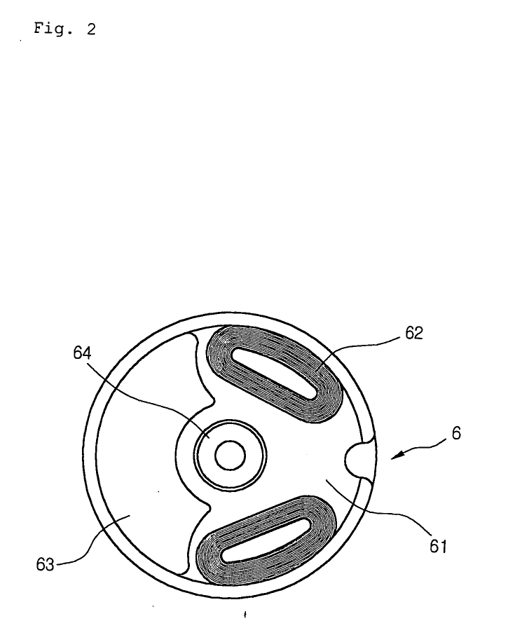

FIG. 3 is a cross-sectional view illustrating a flat vibration motor according to the present invention;

FIG. 4 is a plan view illustrating a rotator according to the present invention; and

FIG. 5 is a cross-sectional view illustrating a vibration motor of another embodiment of the flat vibration motor according to the present invention.

### BEST MODE FOR CARRYING OUT THE INVENTION

Reference will now be made in detail to the preferred embodiments of the present invention, examples of which are illustrated in the accompanying drawings. It will be apparent to those skilled in the art that various modifications and variations can be made therein without departing from the spirit and scope of the invention.

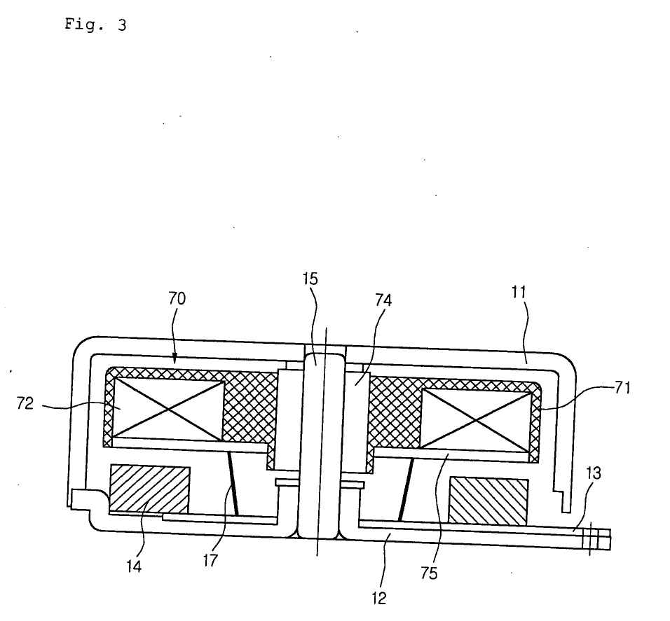

FIG. 3 is a cross-sectional view illustrating a flat vibration motor according to the present invention.

Referring to FIG. 3, the flat vibration motor according to the present invention includes a dish-shaped lower case 12, a substrate 13 installed on the lower case 12, a brush 17 supported elastically on the substrate 13, a magnet 14 placed on the lower case 12 and magnetized to have N and S poles alternatively, an upper case 11 inserted onto a circumference of the lower case 12. A rotating shaft 15 is supported at approximate center of a space between the upper case 11 and the lower case 12. A circular rotator 70 is installed on the rotating shaft 15.

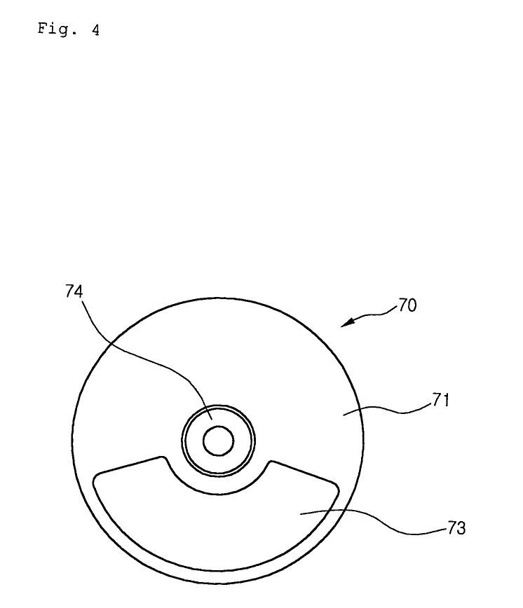

FIG. 4 is a plan view illustrating a rotator according to the present invention.

Referring to FIG. 4, the rotator 70 includes a base 71 made of resin by insert injection molding, a bearing 74 formed at approximate center of the base 71 and allowing the base 71 to rotate smoothly with respect to the rotational shaft 15, a coil 72 (shown in FIG. 3) received inside the base 71, for generating magnetic field due to flowing current, a weight 73 received inside the resin, and a conductive commutator 75 (shown in FIG. 3) connected to an upper portion of the brush 17.

More particularly, the base 71 can be formed by insert injection molding where at least the weight 73 and the coil 72 are placed. The commutator 75 may be formed simultaneously due to the insert injection molding of the base 71.

Here, the coil 72 is not exposed toward the upper portion of the base 71 but received completely inside the base 71. Accordingly, the coil 72 is not found in FIG. 4 that is a plan view of the rotator.

In detail, the magnet 14 grows disk-shaped and magnetized N and S poles alternatively along the circumference.

The operation of the flat vibration motor according to the present invention will be described.

As described above, if a predetermined electric power is supplied to the coil 72 through the substrate 13, a brush 17, and the commutator 75, the magnetic force generated between the coil 72 and the magnet 14 rotates the rotator 70.

Here, since the weight 73 makes the weight center of the rotator 70 be eccentric, the flat vibration motor causes strong vibration when the rotator 70 rotates.

Meanwhile, the method of installing the flat vibration motor according to the present invention employs SMD technique. In other words, the flat vibration motor according to the present invention is directly fixed to an installation member by soldering in SMD technique.

More particularly, describing SMD technique, first, solder cream is coated with a predetermined thickness on the adhesion portions of a surface of the installation member such as the substrate.

Then, the flat vibration motor is placed on the surface coated with solder cream. After the vibration motor is placed, the solder cream-coated surface is heated using a heating means such as a reflow machine so that the flat vibration motor and the substrate are soldered. Here, the heating temperature is about 200-250° C.

Unlike the conventional vibration motor, since the coil 72 is embedded in the base 71 in the present invention, the coil 72 is expanded due to heat but does not exceed the upper portion of the base 71 despite the heating temperature.

In other words, even though the coil 72 is expanded due to heat, since the base 71 suppresses the expansion, the coil 72 does not swell up exceeding the upper portion of the base 71. Accordingly, the coil 72 is placed stably inside the base 71.

The above-mentioned soldering is a kind of welding technique and different from other welding technique in that only the solder cream is melted but the members are not melted so as to the members are adhered.

Since, the soldered members and the solder cream are bonded metal-chemically, it is different from the bonding with adhesion agent.

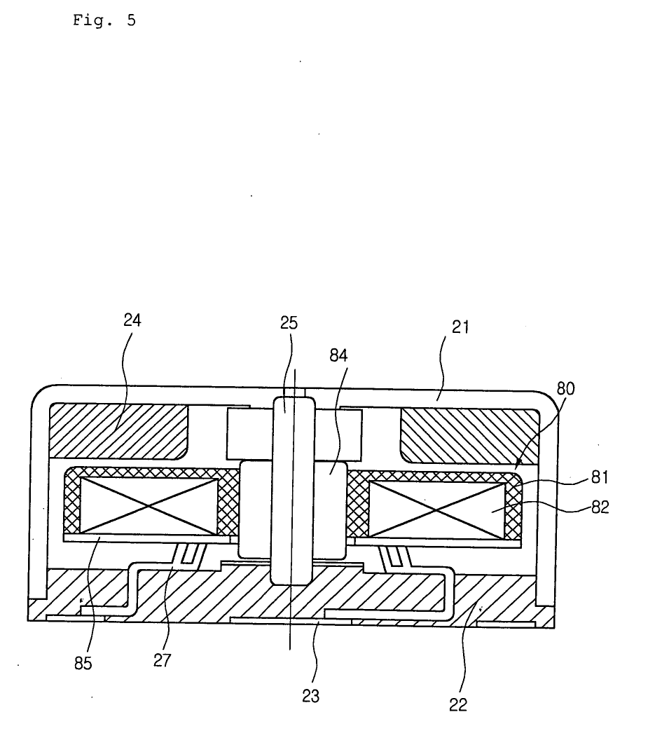

FIG. 5 is a cross-sectional view illustrating a vibration motor of another embodiment of the flat vibration motor according to the present invention.

Referring to FIG. 5, another embodiment of the present invention is different from the original embodiment described above in that the flat vibration motor of another embodiment of the present invention includes a magnet 24 installed on bottom surface inside the upper case 21, a lower fixer 22 for fixing the brush 27, and a terminal 23 formed on a lower surface of the lower fixer 22. The upper case 21, a rotator 80 and a rotational shaft 25 of another embodiment of the present invention are the same as those of the original embodiment described above. In addition, another embodiment of the present invention is the same as the original embodiment described above in that the coil 82 is buried in or covered by the base 81 of resin. The reference 84 that is not described depicts a bearing.

In detail, the lower portion of the rotational shaft 25 is fixed by the lower fixer 22. The function of the lower case 12 suggested by the original embodiment can be performed by the lower fixer 22. The function of the substrate 13 of the original embodiment is performed by the terminal 23.

In addition, since the lower fixer 22 is made of nonconductive material, the original function of the terminal 23 can be performed.

According to the construction described above, a conductive line and the terminal 23 formed on the installation member such as a substrate are electrically connected to each other by the above-mentioned solder. Therefore, current is supplied to the brush 27 so that the vibration motor can rotate.

For this, the solder cream is not coated on the portions of the lower fixer where the terminal 23 is not exposed to exterior.

In another embodiment of the present invention, the vibration motor is placed on the installation member so that the electric connection can be achieved without the substrate and the lower case when the vibration motor is fixed due to the SMD technique. Accordingly, the present invention is very useful.

In another embodiment of the present invention, it can deliberately avoid the problems that are caused since the coil is expanded due to heat of high temperature generated when the SMD technique to place the flat vibration motor is used.

### INDUSTRIAL APPLICABILITY

The present invention prevent the defectives of a vibration motor from being caused since the coil expands due to heat of high temperature when the SMD technique is used. More particularly, the coil is prevented from being contacted with the magnet.

Owing to the above-mentioned construction, the reliability of the vibration motor can be improved.

In addition, since the coil is placed inside the base, the coil is not shaken nor displaced but placed stably, so that the efficiency reduction due to displacement of the coil can be avoided.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A flat vibration motor comprising:
an upper case;
a lower case;
a conductive substrate formed on an upper surface of the lower case;
a magnet formed on the upper surface of the lower case, for generating magnetic field;
a conductive brush having an end electrically connected with the substrate;
a rotational shaft supported at an approximate center portion between the lower case and the upper case;
a rotator inserted onto the rotational shaft to rotate and formed of a resin base;
a commutator formed on a lower surface of the rotator and connected to the other end of the brush; and
a coil having an upper end, which is positioned lower than an upper end of the rotator;
wherein the rotator is made of insert injection molding in which the coil is placed.

2. The flat vibration motor of claim 1, wherein the coil is fixed to the base by an insert injection molding.

3. The flat vibration motor of claim 1, further comprising a weight formed eccentrically inside the rotator, for enhancing eccentricity of weight center of the rotator.

4. The flat vibration motor of claim 1, wherein the coil is fixed by the base.

5. The flat vibration motor of claim 1, wherein the coil is received inside the base so that the coil is firmly fixed when heated.

6. The flat vibration motor of claim 1, wherein the coil is received inside the base so that the coil is not observed at an upper surface of the rotator.

7. A flat vibration motor, comprising:
a case;
a rotational shaft standing at a center portion of the case;
a rotator formed upon a circumference of the rotational shaft and made of resin;
a coil recessed into the rotator so that the coil is firmly fixed when heated; and
a power supply means for supplying a predetermined electric power to the coil.

8. The flat vibration motor of claim 7, wherein the coil is formed on the base by insert injection molding.

9. The flat vibration motor of claim 7, further comprising:
a weight formed eccentrically inside of the rotator, for enhancing eccentricity of weight center of the rotator.

10. The flat vibration motor of claim 7, wherein the coil has an upper portion formed at a position lower than an upper portion of the rotator so that the coil is firmly fixed when heated.

11. The flat vibration motor of claim 7, wherein the power supply means comprises:
a substrate formed on a surface of the case; and
a brush having both ends connected to the substrate and the rotator.

12. The flat vibration motor of claim 7, wherein the power supply means comprises:
a lower insulating fixer formed on a surface of the case;
a conductive terminal formed a lower surface of the lower fixer; and
a brush penetrating the lower fixer and having both ends connected to the terminal and the rotator.

13. A flat vibration motor, comprising:
an upper case having an open lower side;
a lower insulating fixer formed on the lower side of the upper case;
a magnet formed on an inner bottom surface of the upper case, for generating magnetic field;
a rotational shaft standing at a center portion of the upper case and the lower fixer;
a rotator inserted onto the rotational shaft and formed of base made of resin, for rotating;
a conductive terminal formed a lower side of the lower fixer;
a brush penetrating the lower fixer and having an end connected to the terminal and the other end connected to a commutator formed on a lower side of the rotator; and
a coil having an upper portion formed at a position lower than an upper portion of the rotator.

14. The flat vibration motor of claim 13, wherein the coil is formed on the base by insert injection molding.

15. The flat vibration motor of claim 13, further comprising:
a weight formed eccentrically inside of the rotator, for enhancing eccentricity of weight center of the rotator.

16. The flat vibration motor of claim 13, wherein the coil is received inside the base so that the coil is firmly fixed when heated.

17. The flat vibration motor of claim 13, wherein the coil is received inside the base so that the coil is not observed at an upper surface of the rotator.

18. A flat vibration motor, comprising:
a case;
a rotational shaft standing inside the case;
a rotator placed upon a circumference of the rotational shaft;
a coil received in the rotator so that the coil is not exposed to exterior; and
a commutator and a brush for supplying a predetermined electric power to the coil;
wherein the rotator is made of insert injection molding in which the coil is placed.

19. The flat vibration motor of claim 18, wherein the coil is formed on the base made of resin by insert injection molding.
